(19) United States
(12) Patent Application Publication
(10) Pub. No.: US 2008/0297716 A1
(43) Pub. Date: Dec. 4, 2008

(54) EYEGLASSES STRUCTURE

(76) Inventor: Tien-Chun TSAI, Chiayi City (TW)

Correspondence Address: APEX JURIS, PLLC, 12360 LAKE CITY WAY NORTHEAST, SUITE 410, SEATTLE, WA, 98125, US

(21) Appl. No.: 11/757,237

(22) Filed: Jun. 1, 2007

(51) Int. Cl. G02C 11/04

(52) U.S. Cl. 351/51

(57) ABSTRACT

A pair of eyeglasses includes an eyeglasses body, and a light emitting device; the eyeglasses body has a holding room therein, and a covering part thereon, which seals the holding room; the light emitting device is held in the holding room so as to be protected with the covering part; thus, the light emitting device will emit light to prettify the eyeglasses when turned on; furthermore, the wearer of the eyeglasses is prevented from contacting the light emitting device to have accidents.

### BACKGROUND OF THE INVENTION

1. Field of the Invention

The present invention relates to an eyeglasses structure, more particularly one, which contains a light emitting device, and has covering parts to cover and protect the light emitting device so as to prevent the wearer from having accidents.

2. Brief Description of the Prior Art

Currently, the proportion of shortsighted people is much greater than that a decade ago. And, the number of children who have shortsightedness is increasing, and a large proportion of the shortsighted children wear eyeglasses for shortsightedness. In addition, many people, e.g. sportsmen, exercisers, motorcyclists, and car drivers, wear sunglasses to prevent their eyes from being hurt and injured by strong sunlight when engaging in various activities outdoors. And, those people who like pursue fashionable things wear glasses to match their clothing. Therefore, eyeglasses have become a kind of daily necessities. Therefore, the eyeglasses industry makes a large variety of novel, fancy and multifunctional eyeglasses to meet different consumers' needs.

U.S. Pat. No. 7,175,273 taught an “EYEGLASSES HAVING LIGHT EMITTING FUNCTION”, which includes an eyeglasses body, and a light emitting device. The light emitting device is held in a groove formed on a rear side of the eyeglasses body, and comprises a circuit board, a luminescent tube-shaped light source connected to the circuit board, a power supplying unit connected to the circuit board, and a switch installed on the circuit board to be used for operating the light emitting device.

The eyeglasses have the following drawbacks:

1. The light emitting device is only inserted in the groove of the eyeglasses body therefore it is exposed, and can cause accidents to the wearer of the eyeglasses.

2. The light emitting device is inserted in the groove of the eyeglasses body, and in turn the luminescent tube-shaped light source has to be pulled out for replacement if the luminescent tube-shaped light source is faulty/damaged. Consequently, the eyeglasses body can be broken when the tube-shaped light source is being pulled out.

### SUMMARY OF THE INVENTION

It is a main object of the present invention to provide an improvement on an eyeglasses structure to overcome the above problem.

An eyeglasses structure according to an embodiment of the present invention includes an eyeglasses body, and a light emitting device. The eyeglasses body has a holding room therein, and a covering part positioned thereon, which seals the holding room. The light emitting device is held in the holding room so as to be protected with the covering part. Therefore, the light emitting device will emit light to prettify the eyeglasses to make the eyeglasses more attractive and pleasant-looking when turned on. Furthermore, the wearer of the eyeglasses is prevented from contacting the light emitting device to get injured/have accidents.

### BRIEF DESCRIPTION OF THE DRAWINGS

The present invention will be better understood by referring to the accompanying drawings, wherein:

FIG. 1 is an exploded perspective view of the first embodiment,

FIG. 2 is a sectional view of the first embodiment,

FIG. 3 is a circuit diagram of the first embodiment,

FIG. 4 is an exploded perspective view of the second embodiment,

FIG. 5 is a front view of the third embodiment of the invention,

FIG. 6 is a sectional view of the third embodiment, and

FIG. 7 is a circuit diagram of the third embodiment.

### DETAILED DESCRIPTION OF THE PREFERRED EMBODIMENTS

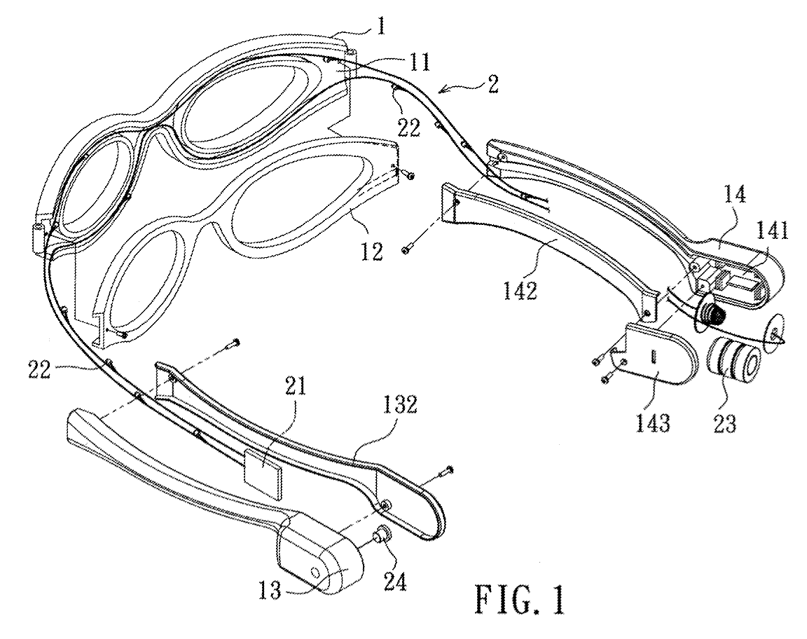

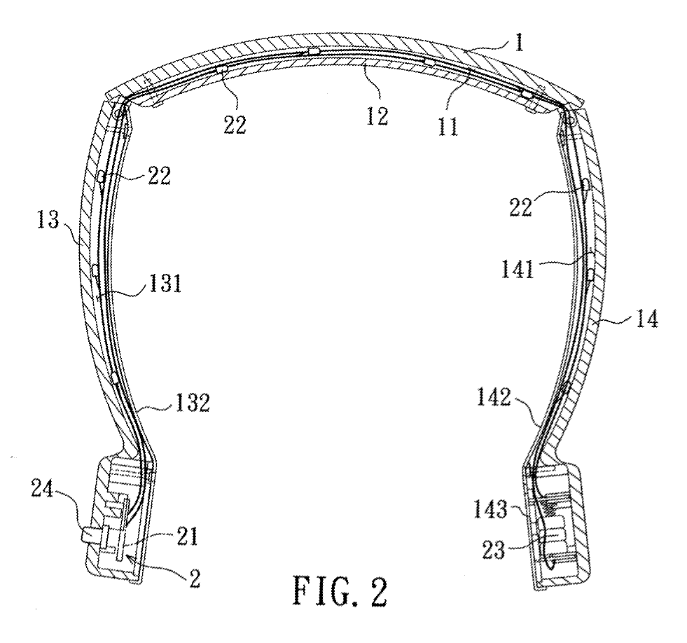

Referring to FIGS. 1 and 2, a first preferred embodiment of eyeglasses structure of the present invention includes an eyeglasses body 1, left and right temples 13 and 14 pivoted on two ends of the eyeglasses body 1, and a light emitting device 2.

The eyeglasses body 1 has a holding room 11 on a rear side thereof, and a covering part 12 positioned on the rear side so as to seal the holding room 11. The left and the right temples 13 and 14 have left and right holding rooms 131 and 141 respectively, which face each other. In addition, the left temple 13 has a left covering part 132 thereon, which seals the left holding room 131. And, the right temple 14 has a right covering part 142, which covers a front section of the right holding room 141. The right temple 14 further has a power source covering 143, which covers a rear section of the right holding room 141, and which is easy to place in position and separate from the right temple 14 for allowing replacement of the power source 23.

The light emitting device 2 includes a circuit board 21, several light sources 22 electrically connected to the circuit board 21, a power source 23 connected to the circuit board 21, and a switch 24 provided on the circuit board 21 to control the light sources 22; the light sources 22 can be light emitting diodes (LED), and the power source 23 can be batteries.

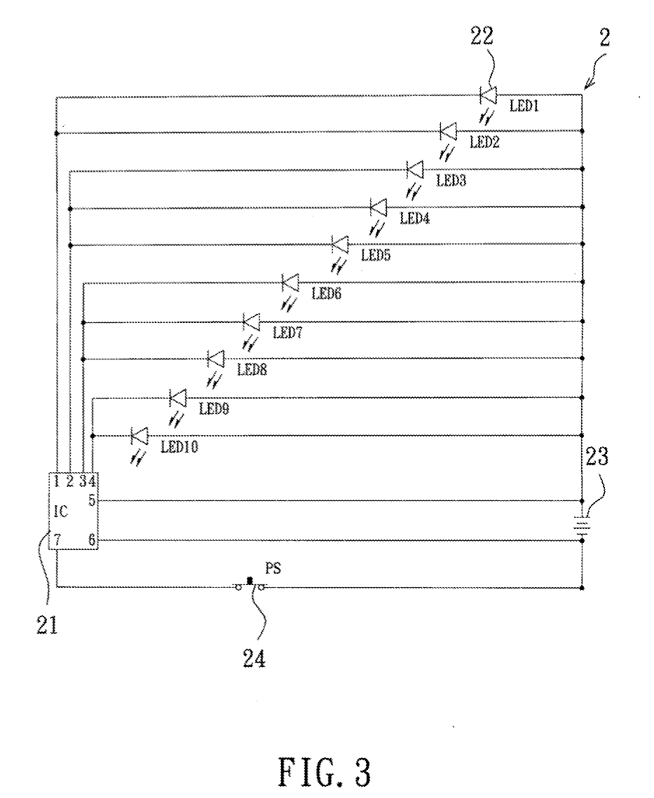

Referring to FIG. 3, the light emitting device 2 is partly inserted in the holding room 11 of the rear side of the eyeglasses body 1 so that the light sources 22 thereof are spaced apart in the holding room 11. And, the circuit board 21 and the switch 24 of the light emitting device 2 are inserted in the left holding room 131 of the left temple 13 while the power source 23 of the light emitting device 2 is inserted in the rear section of the right holding room 141 of the right temple 14; thus, the light emitting device 2 is protected by means of the covering part 12, the left and the right covering parts 132, 142, and the power source covering 143.

Therefore, the light sources 22 of the light emitting device 2 can be made to emit light/turned off by means of operating the switch 24. And, the light sources 22 can be made to emit light in one of various manners, e.g. to flash on and off repeatedly. And, the light sources 22 can be made to start emitting light in another color instead by means of operating the switch 24.

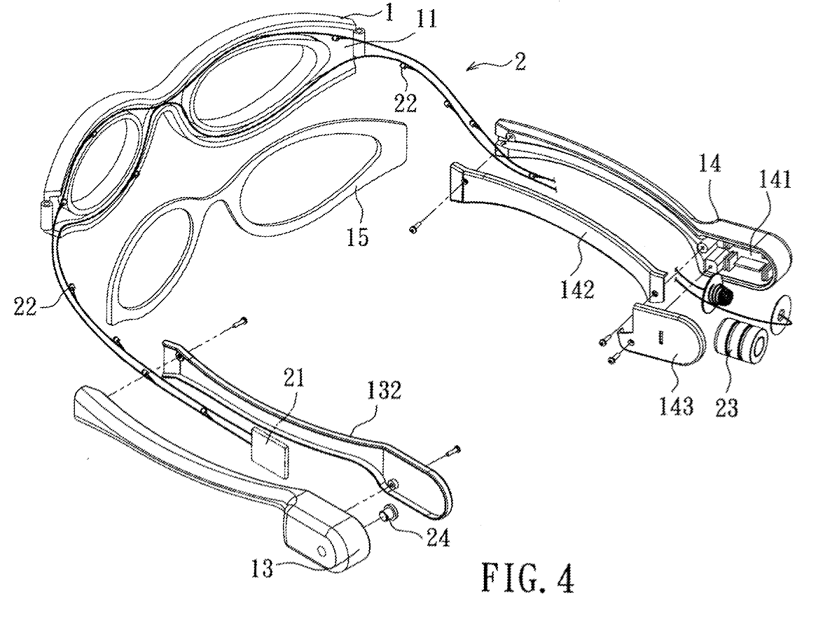

Shown in FIG. 4 is a second preferred embodiment of an eyeglasses structure of the present invention, which is basically the same as the first preferred embodiment. But, the second preferred embodiment has a pressing plate 15 stuck on a rear side of an eyeglasses body 1 to seal a holding room 11 in the eyeglasses body 1 and protect a light emitting device 2 held in the holding room 11 instead. Therefore, if light sources 22 of the light emitting device 2 get damaged, the pressing plate 15 can be easily detached from the eyeglasses body 1 for allowing the light sources 22 to be replaced with new ones.

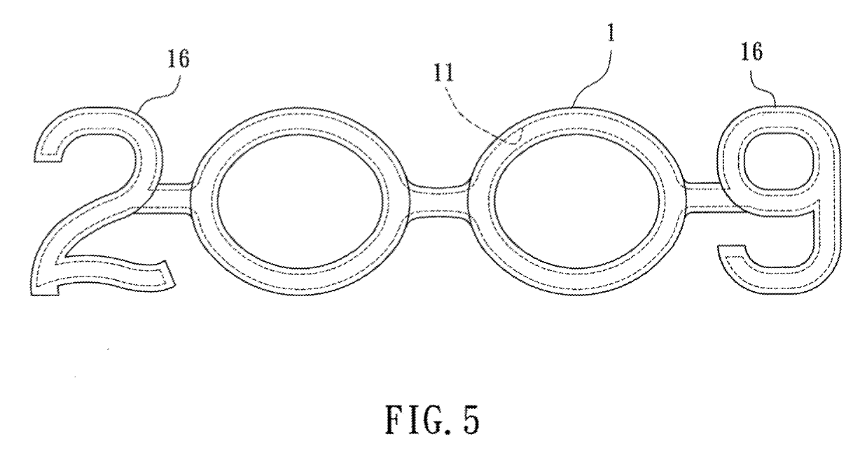

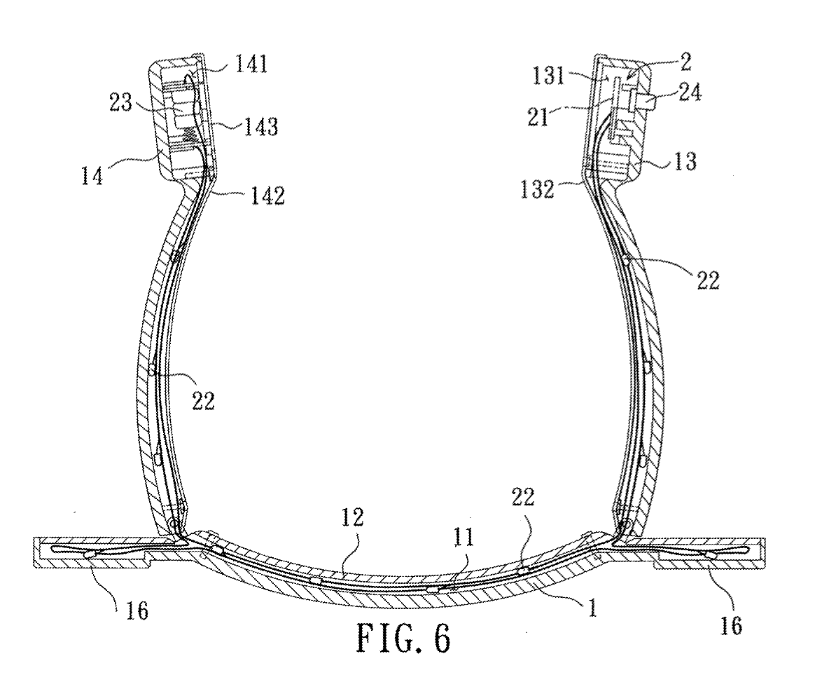

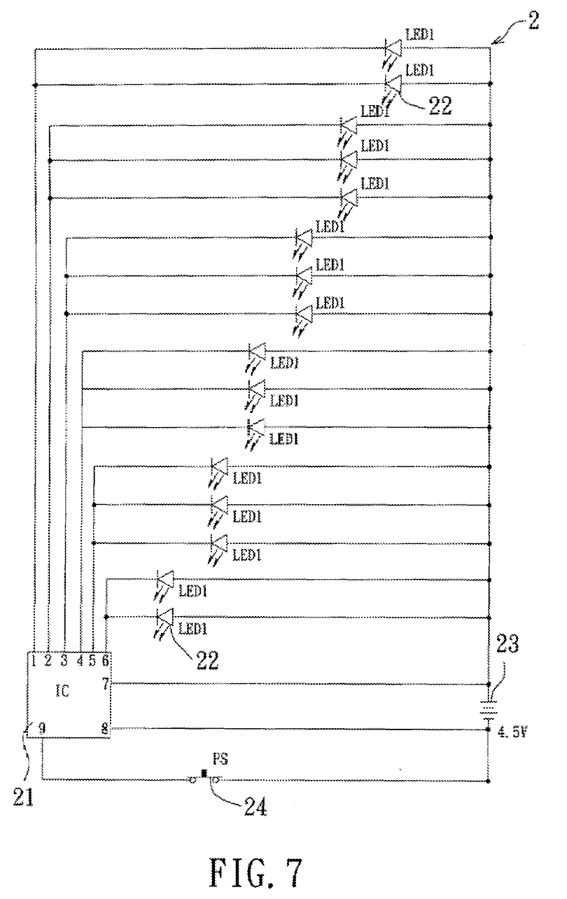

Shown in FIGS. 5, 6, and 7 is a third preferred embodiment of eyeglasses structure of the present invention, which has extending portions 16 on two ends of the eyeglasses body 1 besides having all of the components of the first preferred embodiment; the eyeglasses body 1 comprises two circular parts, and one of the extending portions 16 is in the shape of a “2”, and the other in the shape of a “9” so that a front of the eyeglasses body 1 is in the shape of a “2009”. Furthermore, the light emitting device 2 is partly inserted in the extending portions 16.

From the above description, it can be seen that the present invention has the following advantages:

1. The eyeglasses are equipped with the light emitting device, which will emit light to prettify the eyeglasses to make the eyeglasses more attractive and pleasant-looking when turned on.

2. The eyeglasses have several covering parts to protect the light emitting device therefore the wearer of the eyeglasses is prevented from contacting the light emitting device to have accidents.

3. The eyeglasses have a “2” shaped and a “9” shaped extending portions on two ends of the body thereof therefore the front of the eyeglasses is in the shape of a “2009” to be entertaining.

4. When the light sources of the light emitting device are faulty/damaged, the covering parts can be easily separated from the eyeglasses body for allowing replacement of the light sources of the light emitting device, without causing damage to the eyeglasses.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

1. An eyeglasses structure, comprising
an eyeglasses body, which has a holding room therein; and
a light emitting device held in said holding rooms;
and characterized by: the eyeglasses body having a covering part, which seals said holding room, and protects said light emitting device wherein said light emitting device includes a circuit board, a plurality of light sources connected to said circuit board, a power source connected to said circuit board, and a switch provided on said circuit board to control said light sources;
said eyeglasses structure further comprises a left temple and a right temple that are pivoted to said eyeglasses body; the left and the right temples having left and right holding rooms respectively; the left temple having a left covering part thereon, which seals the left holding room; the right temple having a right covering part thereon, which seals the right holding room.

2. (canceled)

3. The eyeglasses structure as recited in claim 1, wherein said covering part is a pressing plate.

4. The eyeglasses structure as recited in claim 1, wherein said light sources are light emitting diodes.

5. The eyeglasses structure as recited in claim 1, wherein said power source is batteries.

6. (canceled)

7. The eyeglasses structure as recited in claim 6, wherein said right temple is covered with a power source covering.

8. The eyeglasses structure as recited in claim 1 further comprising extending portions, which are formed on two ends of said eyeglasses body respectively.
